(19) United States
(12) Patent Application Publication
(10) Pub. No.: US 2009/0002192 A1
(43) Pub. Date: Jan. 1, 2009

(54) Dive computer system

(76) Inventor: Charles Whiteman, Fort Lauderdale, FL (US)

Correspondence Address: Dickinson Wright PLLC, 38525 Woodward Avenue, Suite 2000, Bloomfield Hills, MI, 48304, US

(21) Appl. No.: 11/538,941

(22) Filed: Oct. 5, 2006

Related U.S. Application Data
(60) Provisional application No. 60/723,809, filed on Oct. 5, 2005.

(51) Int. Cl. H04B 13/02

(52) U.S. Cl. 340/850

(57) ABSTRACT

A method of operating a dive information tracking system is disclosed wherein a diver or user carries or wears an underwater computer during an underwater dive. The underwater computer acquires information during the current underwater dive and the newly acquired information is wirelessly and automatically communicated to a central database that is connected to the world wide web of computers.

### CROSS REFERENCE TO RELATED APPLICATION

The present invention claims priority from U.S. Provisional Patent Application Ser. No. 60/723,809, filed Oct. 5, 2005, and entitled “Dive Computer System.”

### TECHNICAL FIELD

The present invention relates generally to a computer system for capturing and storing underwater dive information and more particularly to an automated computer system for capturing and storing underwater dive information.

### BACKGROUND OF THE INVENTION

Underwater diving is a popular and in some situations a necessary activity. Divers who participate in this activity do so for a variety of reasons. Some enjoy this activity for recreational purposes and others are employed to engage in the activity. Underwater diving can be performed on several different levels. Divers who wish to stay near the surface of the water often use snorkeling equipment. Others who wish to dive into deeper water require more elaborate equipment. Underwater diving at greater depths is also referred to as SCUBA diving. SCUBA is an acronym for “self contained underwater breathing apparatus.”

Equipment is used to assist divers' breathing while both snorkeling and SCUBA diving. While snorkeling, a diver breathes through a U-shaped tube that extends above water while keeping his or her face in the water. While SCUBA diving, a diver breathes oxygen supplied in a tank that is typically worn on the diver's back.

There are many known devices that have been developed over the years to aid divers in their underwater adventures. One such device is an underwater computer. More specifically, one type of underwater computer is commonly referred to as a dive computer. While the dive computer is most commonly used by SCUBA divers, it can also be used by snorkelers. One known type of dive computer is a device that measures the time and depth of a dive. In some cases it can calculate and display a safe ascent rate for the diver.

It is also common for a diver to take another type of underwater camera on their underwater dives. These types of cameras are designed for underwater use to acquire both still pictures and video that document the diver's underwater experience.

Currently, it is known that the information acquired on either the underwater computer or camera during the underwater dive can be subsequently downloaded to a database upon completion of the dive for post dive use by the diver. The transfer of information is known to be performed by physically connecting the underwater computer to a land-based computer to download the newly acquired information.

Therefore, there is a need for underwater computers, including dive computers and cameras, to wirelessly connect to the World Wide Web of computers, also referred to as the Internet, and upload information, such as acquired during a dive, to a central database.

### SUMMARY OF THE INVENTION

It is therefore an object of the present invention to provide a method of operating an underwater dive information tracking system that allows information obtained during an underwater dive to be immediately wirelessly communicated to a central database and immediately accessible.

In accordance with the objects of the present invention, a method of operating a dive information tracking system is provided wherein the user, or diver, carries or wears an underwater computer during an underwater dive. After being activated, the underwater computer is able to store or access multiple user profiles and can wirelessly communicate with a central database that is accessible via the World Wide Web of computers. The user or diver activates the underwater computer and selects a user profile. The underwater computer acquires dive information during the current underwater dive for the selected user profile. The underwater computer wirelessly communicates with the Internet and the acquired dive information is uploaded to the central database after completion of the underwater dive. The wireless communication occurs automatically and seamlessly.

Other objects and features of the present invention will become apparent when viewed in light of the detailed description when taken in conjunction with the attached drawings and claims.

### BRIEF DESCRIPTION OF THE DRAWINGS

FIG. 1 is a schematic view of a system for communicating with a dive computer in accordance with an embodiment of the present invention;

FIG. 2 is a schematic view of a system a method for communicating with a wireless dive computer in accordance with one embodiment of the present invention; and

FIGS. 3-5 are flowcharts of methods in accordance with embodiments of the present invention.

### DESCRIPTION OF INVENTION

In the following description, various operating parameters and components are described for a number of constructed embodiments. The specific parameters and components are included as examples and are not meant to be limiting.

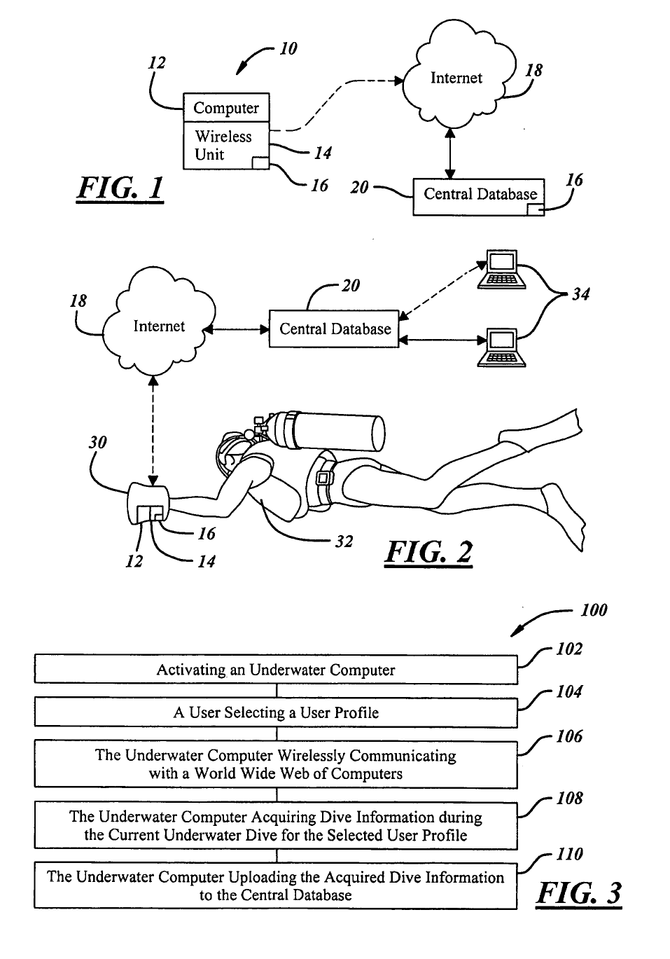

Referring now to the figures, like numerals are used to designate like structure throughout the figures. In FIG. 1, a schematic diagram of an underwater computer system 10 is illustrated, including an underwater computer 12 in accordance with one embodiment of the present invention. The underwater computer 12 may be coupled to or located within any items carried or worn by a user or diver 32 during a dive. The underwater computer 12 includes a wireless unit 14 that allows for wireless Internet communication. The wireless unit may be any commercially available device for effectuating wireless communication with a computer, computer network or the Internet as will be understood by one of ordinary skill in the art. A central database 20 stores all of the acquired and accumulated dive information and is accessible via the Internet 18. The Internet 18 is also referred to as the World Wide Web of computers. Therefore, the underwater computer 12 may wirelessly upload information obtained during the current underwater dive to the central database 20 via the Internet 18. It will be understood that the information may be uploaded at any time, including during the dive, immediately after the dive, or at some point thereafter. The downloading is preferably initiated by the central database 20 upon regular intervals or based upon a predetermined trigger, as discussed in more detail below.

The underwater computer 12 may be a dive computer typical of those used for SCUBA diving. One such example is a dive computer that is worn on the user's wrist, similar to a wristwatch. In another embodiment, the underwater computer 12 is a camera 30 that is capable of acquiring still pictures or video.

In operation, the underwater computer 12 is activated by the user, such as before initiation of a dive. At this point, the user 32 is prompted to select a user profile that contains information that uniquely identifies and is uniquely associated with that user 32. The local underwater computer 12 may have multiple user-entered user profiles 16 to allow dive information unique to each user and user profile to be tracked and appropriately stored. When the computer 12 is used, it prompts the user 32 to confirm his or her identify from the stored profiles 16. Alternatively, a new user can create a new unique profile. In another embodiment, the user profiles 16 are stored in the central database 20 and downloaded to the computer 12 upon request or initiation by the user 32.

The underwater computer 12 acquires dive information during the current underwater dive and stores the acquired information in a manner associated with the selected user profile 16. There are various types and categories of information that could possibly be acquired during an underwater dive, including but not limited to, information relating to the duration of the dive, information relating to the location of the dive, and information relating to the depth of the dive.

Either during the dive or upon completion or the dive, the underwater computer 12 wirelessly communicates with the World Wide Web of computers 18. The underwater dive computer 12 may communicate wirelessly via the Internet 18 in any number of methods including, but not limited to, via a wi-fi connection, via a cellular network connection, or any other transmittal method known in the art. Again, as set forth above, the computer 12 preferably communicates automatically with the central database 20 to upload the information from the computer 12. Further, the automatic communication is preferably initiated by a computer associated with the central database 20. Indeed, it is preferred that the transfer of information from the computer 12 to the central database 20 occurs seamlessly.

The acquired dive information is uploaded to the central database 20 during the current underwater dive. In one embodiment, the underwater computer 12 is manually activated by the user 32 to upload the acquired dive information to the central database 20. In another embodiment, the computer 12 automatically uploads the acquired dive information to the central database 20 at a triggering event. The triggering event could be when new dive information is acquired on the underwater computer 12 during the current dive. For example, when a new user profile 16 is entered using the underwater computer 12 the computer will automatically upload the new information to the database 20 via a wireless Internet connection. In other words, any new information entered or detected by the underwater computer 12 will prompt the computer 12 to communicate with the central database 20. The central database 20 could be the user's personal database, or it could be a database that is managed by a database manager. For example, a managed database might be used if a diver has organized a dive through a particular company and has rented their dive equipment. Alternatively, the central database 20 can periodically communicate with the computer 12 at predetermined intervals to check and see if the computer 12 has new information stored therein for downloading.

The database 20 may be used for the following purposes: user access and enhance their online dive log; dive operators confirm a divers' experience by accessing this data; the central database 20 or company associated with the central database 20 uses this data to: track diver habits to develop personalized offers and marketing efforts based on this data and appropriately direct these efforts at them; reward divers for diving more often or in more new places; insure divers more efficiently; prompt divers to service their equipment as needed perhaps based on usage.

Further, by having the central database 20 managed by a dive company or entity in the dive industry, it allows the company to track the habits or activities of a multitude of different divers and utilize this information to send out information, such as service updates, promotional information or other information that may be of interest to the diver. It also allows the entity to offer other services to the diver.

Referring to FIG. 2, another embodiment of the present invention is illustrated where the computer is a digital camera 30 including wireless Internet communication capabilities 14 built therein. The camera 30 also contains multiple user-entered user profiles 16. When the camera 30 is used, the camera 30 prompts the user 32 to confirm his or her identity from the stored user profiles. The camera 30 automatically connects to the Internet 18 (in the same manner discussed above) and uploads photographs to a configurable Internet destination, such as the central database 20, for the following purposes: users may access and enhance their online photo gallery through private user terminals 34; users may configure their online photo gallery with options including auto email notifying friends and family that the gallery has been updated; and the central database 20 or associated company may ensure certain paid services available to users such as photo correction & enhancement, photo printing & framing, and DVD production. While the camera 30 is shown as a dive camera, it will be understood that the disclosed system and method can be utilized in connection with any digital camera whether for underwater purposes or not. The camera 30 need only include an apparatus for effectuating wireless communication with a central database 20, such as by the central database seamlessly initiating connection with the camera 30.

Referring to FIG. 3, a logic flow diagram 100 for a method of operating a dive information tracking system is illustrated in accordance with an embodiment of the present invention. In operation block 102, an underwater computer is activated before, during or after a dive. In operation block 104, the user selects a user profile by either confirming a stored identity or creating a new user profile. In operation block 106, the underwater computer wirelessly communicates with a World Wide Web of Computers. In operation block 108, the underwater computer acquires dive information during the current underwater dive for the selected user profile. In operation block 110, the underwater computer uploads the acquired dive information to the central database during the underwater dive.

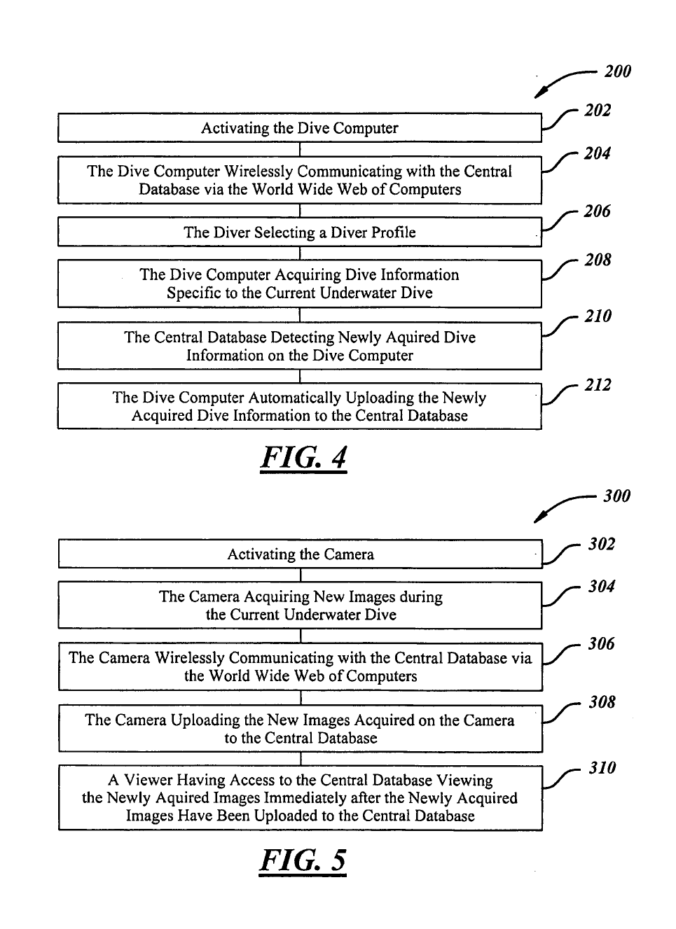

Referring to FIG. 4, a logic flow diagram 200 for a method of automatically, wirelessly updating dive information in a central database for an underwater dive is illustrated in accordance with an alternative embodiment of the present invention. In operation block 202, the dive computer is activated either before, during or after a dive. In operation block 204, the dive computer wirelessly communicates with the central database via the World Wide Web of Computers. In operation block 206, the diver selects a diver profile. In operation block 208, the dive computer acquires dive information specific to the current underwater dive. In operation block 210, the central database detects newly acquired dive information on the dive computer. In operation block 212, the dive computer automatically uploads the newly acquired dive information to the central database after detecting newly acquired information on the dive computer in a seamless manner.

Referring to FIG. 5, a logic flow diagram 300 for a method of automatically and wirelessly transmitting images acquired on a camera during an underwater dive to a central database is illustrated in accordance with another alternative embodiment of the present invention. In operation block 302, the camera is activated. In operation block 304, the camera acquires new images during the current underwater dive. In operation block 306, the camera wirelessly communicates with the central database via the World Wide Web of Computers during the current underwater dive. In operation block 308, the camera uploads the new images acquired on the camera to the central database during the current underwater dive. In operation block 310, a viewer has access to the central database viewing the newly acquired images immediately after the newly acquired images have been uploaded to the central database.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A method of operating a dive information tracking system wherein a user carries or wears an underwater computer during an underwater dive, the underwater computer is able to store or access multiple user profiles and is able to wirelessly communicate with a central database that is accessible via the World Wide Web of computers, the method comprising the steps of:
activating an underwater computer;
a user selecting a user profile;
the underwater computer wirelessly communicating with a World Wide Web of computers;
the underwater computer acquiring dive information during the current underwater dive for the selected user profile; and
the underwater computer uploading the acquired dive information to the central database the underwater dive.

2. The method of claim 1 wherein the underwater computer is a dive computer.

3. The method of claim 1 wherein the underwater computer is a camera.

4. The method of claim 1 wherein the user creates a new user profile.

5. The method of claim 1 wherein the user selects a preexisting user profile.

6. The method of claim 1 wherein the underwater computer wirelessly communicates with the World Wide Web of computers via a wi-fi connection.

7. The method of claim 1 wherein the underwater computer wirelessly communicates with the World Wide Web of computers via a cellular network connection.

8. The method of claim 1 wherein the underwater computer acquires information relating to the duration of the dive.

9. The method of claim 1 wherein the underwater computer acquires information relating to the location of the dive.

10. The method of claim 1 wherein the underwater computer acquires information relating to the depth of the dive.

11. The method of claim 1 wherein the underwater computer acquires information relating to pictures taken during the dive.

12. The method of claim 1 wherein the underwater computer automatically uploads the acquired dive information to the central database at a triggering event.

13. The method of claim 12 wherein the triggering event is when new dive information is acquired on the underwater computer.

14. The method of claim 1 wherein the underwater computer is manually activated by the user to upload the acquired dive information to the central database.

15. The method of claim 1 wherein the central database is the user's personal database.

16. The method of claim 1 wherein the central database is managed by a database manager.

17. A method of automatically wirelessly updating dive information in a central database for an underwater dive in which a diver carries a dive computer on an underwater dive wherein the dive computer wirelessly communicates with the World Wide Web of Computers and the central database is connected to the World Wide Web of Computers, the method comprising the steps of:
activating the dive computer;
the dive computer wirelessly communicating with the central database via the World Wide Web of Computers;
the diver selecting a diver profile;
the dive computer acquiring dive information specific to the current underwater dive;
the central database detecting newly acquired dive information on the dive computer; and
the dive computer automatically uploading the newly acquired dive information to the central database.

18. The method of claim 15 wherein each diver profile is saved on the dive computer.

19. The method of claim 15 wherein each diver profile is saved on the central database.

20. A method of automatically and wirelessly transmitting images acquired on a camera during an underwater dive to a central database that is connected to and communicates with the World Wide Web of Computers, the method comprising the steps:
activating the camera;
the camera acquiring new images during the current underwater dive;
the camera wirelessly communicating with the central database via the World Wide Web of Computers during the current underwater dive; and
the camera uploading the new images acquired on the camera to the central database during the current underwater dive.

21. The method of claim 20 further comprising the step of:
a viewer having access to the central database viewing the newly acquired images immediately after the newly acquired images have been uploaded to the central database.

22. The method of claim 21 wherein images includes still pictures and video images.
